(19) United States
(12) Patent Application Publication
(10) Pub. No.: US 2004/0143596 A1
(43) Pub. Date: Jul. 22, 2004

(54) Content distributon method and apparatus

(76) Inventor: Mark Sirkin, White Plains, NY (US)

Correspondence Address: NIXON PEABODY, LLP, 401 9TH STREET, NW, SUITE 900, WASINGTON, DC, 20004-2128, US

(21) Appl. No.: 10/346,166

(22) Filed: Jan. 17, 2003

(51) Int. Cl. G06F 7/00

(52) U.S. Cl. 707/104.1

(57) ABSTRACT

A content distribution system and method for providing content to users within an enterprise based on the roles of user's within the enterprise. The system includes at least one source of items of content, at least one content consumer device, and a content server. The content server accepts items of content from the source and processes the items of content for said content consumer device in accordance with human capital needs of a user of said content consumer device serving in at least one role within the enterprise.

### BACKGROUND

The invention relates generally to content distribution and more specifically to a method and apparatus for segregating and displaying content in accordance with the human capital needs of a user serving in a role for an enterprise.

Today's economy is based on information. Businesses that acquire relevant information and disseminate that information to the proper groups and individuals are at a competitive advantage. However, the sheer quantity of information (referred to as “content” herein) from various sources, such as periodicals, enterprise business process systems, electronic mail, and the Internet in general, can be problematic. In fact, often the amount of information available to individuals within an enterprise is overwhelming. Finding information is no longer difficult. The primary challenge is providing the right information to the right people so that the information can be transformed into usable knowledge.

Recently, the concept of “human capital” has received great attention in the business world. The term “human capital” generally refers to the practical knowledge, acquired skills and learned abilities of an individual that make him or her productive. A company has both tangible and intangible assets. The tangible assets are easily valued and accounted for; they include machinery, real estate, and inventory, for example. The intangible assets are more difficult to assess; they include human capital and brand value, for example. There is a growing body of evidence that indicates, however, that these intangible assets represent a significant, and growing, proportion of the true value, as well as the economic valuation, of most companies in the information economy. Some estimates set human capital value at over 75% of the wealth of the United States. Further, studies have indicated that shareholder investment return is directly related to a company's ability to effectively manage human capital.

Accordingly, the ability to manage, maintain, and develop human capital is essential for any company to remain competitive in today's business environment. Investments that improve the human capital aspects of a person working within an enterprise, i.e., increase the practical knowledge, acquired skills, and learned abilities of an individual, or that make him or her more productive in other ways, increase that person's value to the enterprise. This increased emphasis on human capital has given rise to the concept of Human Capital Management (HCM). In other words, human capital is becoming more significant to businesses because economies, companies, and jobs are increasingly based on knowledge activities rather than physical labor and raw materials. Knowledge and skills that once lasted a lifetime now need to be updated every three to four years. The information that most professionals use to do their jobs changes constantly, and the ability to keep up with these changes is integral to the challenges of modern working life in the information age. The more informed, educated, and skilled people are, the more valuable they will be to themselves and employers.

The increase in the perceived value of human capital has caused many organizations to attempt to manage human capital, using various HCM techniques, much as they have managed other assets in the past. As noted above, a primary aspect of human capital is the knowledge of persons within an organization. Such knowledge is increased by providing the right information, and only the right information, to the appropriate people at the appropriate time. Stated succinctly, the importance and availability of information has increased the value of human capital. There is an increasing need to manage the raw information flow that empowers the human capital in an organization. Accordingly, the problem with information flow and delivery has been given even greater attention over recent years. However, the amount of information continues to increase and tools for handling that information are limited.

For example, there are currently a plethora of online content sources available to enterprises and individuals. An example of sophisticated and specific content is Bloomberg LP™ which licenses information services to the financial community. At the other end of the spectrum is AOL Time Warner™, which provides Internet information services directed to families and individuals. Each of these services provides a great deal of content segregated or searchable based on categories and keywords. However, even within a single information service, the amount of content can be staggering. Also, finding relevant content is a proactive process of browsing and/or searching. Further, users are constantly bombarded with content in the form of facsimile messages, email messages, and other documents. Various tools are known to organize such documents. However, the amount and diversity of such documents renders it difficult to distribute content in an organized manner.

To alleviate information overload, content management systems and portal platforms have been developed. These technologies deliver aggregated content in a “dashboard” format. While the format and subject matter of content display is configurable, such systems tend to provide a “one size fits all” solution for an enterprise. Also, the configuration is based on preferences or keywords entered by the user or another party. Other known systems and methods have distributed content through filters, query responses, and the like. In each case, the information provided to a user is related to what the user or other party wants or thinks they need.

### SUMMARY OF THE INVENTION

A first aspect of the invention is a content distribution system for providing content to users within an enterprise based on the roles of user's within the enterprise. The system comprises at least one source of items of content, at least one content consumer device, and a content server configured to accept items of content from the source and process the items of content for said content consumer device in accordance with human capital needs of a user of said content consumer device serving in at least one role within the enterprise.

A second aspect of the invention is a content distribution system for providing content to users within an enterprise based on at least one role of the users within the enterprise. The system comprises at least one source of plural items of content, at least one content consumer device, means for determining attributes of participation of a user of the content consumer device in at least one business process, the attributes of participation including the purpose of the at least one business process of an enterprise, and a content server configured to accept items of content from the source and provide relevant items of content to the content consumer device in accordance with the attributes of participation. The content server is operative to segregate the relevant items of content into display segments based on the attributes of participation.

A third aspect of the invention is a display system for use in connection with a content distribution system of an enterprise. The display system comprises means for segregating items of content into display segments based on the attributes of participation of a user in business processes of an enterprise, and means for displaying the items of content in one of plural display segments including a segment for items of content related to activities of the user that create value for the enterprise, a segment for items of content that relate to collaboration between the user and others in the enterprise, a segment for items of content that relate to unique interests of the user within the enterprise, and a segment for items of content that relate to interests of the user outside of the enterprise.

A fourth aspect of the invention is a method for providing content to users within an enterprise based on the roles of user's within the enterprise. The method comprises determining human capital needs of a user of a content consumer device serving in a role within the enterprise, receiving items of content from at least one source of items of content, and providing selected items of content to the content consumer device in accordance with human capital needs of the user of the content consumer device serving in at least one role within the enterprise.

A fifth aspect of the invention is a method of determining the informational needs of a cohort of users in a manner that increases the human capital value of the users in their at least one role within an enterprise. The method comprises identifying a cohort of users having substantially homogenous roles within the enterprise, identifying a sample group of users corresponding to the cohort of users, gathering data of the users in the sample group relating to business processes of the community, determining business processes of the cohort based on the data, identifying content that is relevant to the business processes determined in the determining step, and designing an interface for presenting the relevant content.

### BRIEF DESCRIPTION OF THE DRAWING

The invention will be described through a preferred embodiment and the attached drawing in which:

FIG. 1 is a schematic illustration of a computer architecture for a content distribution system in accordance with the preferred embodiment;

FIG. 2 is a block diagram of the content server of FIG. 1;

FIG. 3 is a schematic illustration of content quadrants of a display of the preferred embodiment;

FIG. 4 is an example of a display in accordance with the CORE quadrant of FIG. 3;

FIG. 5 is an example of a display in accordance with the CULTURE quadrant of FIG. 3;

FIG. 6 is an example of a display in accordance with the CREATIVE quadrant of FIG. 3;

FIG. 7 is an example of a display in accordance with the COMMUNITY quadrant of FIG. 3;

FIG. 8 is a flowchart of the work process determination procedure of the preferred embodiment; and

FIG. 9 is an example of a questionnaire that can be used in the procedure of FIG. 5.

### DETAILED DESCRIPTION

Applicant has discovered that the actual information needs of a specific person within an enterprise are dependant on the role that person plays within the enterprise, their relationship to others, the culture of the enterprise, and the personal life of the person. Existing systems do not account for this complex interrelationship and thus such systems miss the mark in providing the most relevant content in a manner that maximizes human capital. In summary, it is not enough to allow workers to access disparate, un-integrated “pools” of information. The most productive work, and the information that enables it, happens in a context that integrates person, work role, organizational culture, and community. The preferred embodiment of the invention described below processes content in accordance with both human capital development, i.e., maximizing a person's relevant knowledge, and human capital deployment, i.e., utilizing persons and their knowledge efficiently.

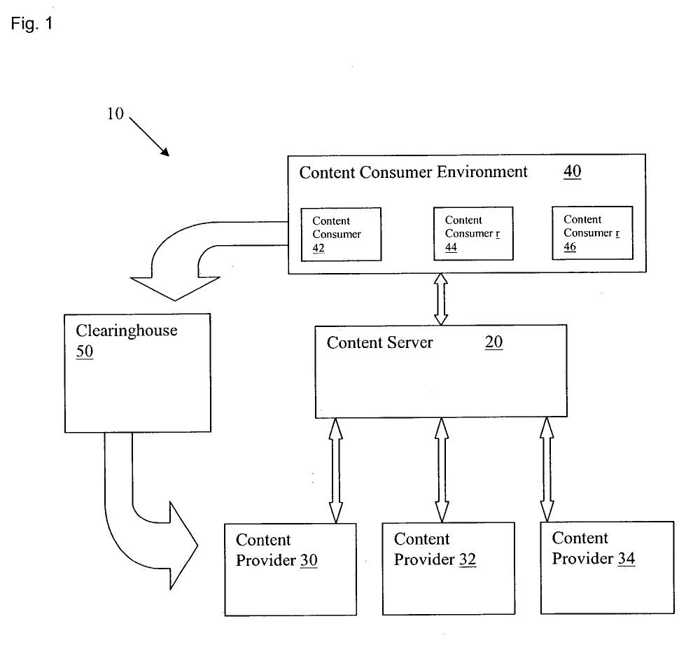

FIG. 1 illustrates a computer architecture in accordance with the preferred embodiment. Architecture 10 includes content server 20, content consumer environment 40, content provider 30, content provider 32, and content provider 34. Content consumer environment 40 is any type of environment having content users, such as an enterprise network or other group of devices. For example, content consumer environment 40 can be the LAN of a business, such as a manufacturing company or a law firm. Content consumer environment 40 includes content consumer 42, content consumer 44, and content consumer 46 which can be the personal computers, or other devices of users in content consumer environment 40. The users have specific roles within the enterprise as will be described in detail below. Clearinghouse 50 serves to track content distribution and/or use as well as financial and accounting transactions in a known manner. There can be any number of content providers and any number of consumer environments having any number of content consumers and/or devices associated with content consumers. For the sake of simplicity, each content provider is referenced individually and collectively with as content provider 30 below and each content consumer is referenced individually and collectively as content consumer 42 below.

Content provider 30 can be any type of content provider such as an online service, an email server, a document server, a Web server, a repository, an internal business process system, or the like. Content is provided from content provider 30 to content server 20 through any type of communication link, such as the Internet, a LAN, a direct computer to computer connection, or the like. Content server 20 filters, segregates, or otherwise processes the content and distributes the processed content to content consumer 42 for display in accordance with the specific needs of the users associated with each content consumer 42. The processing of content by content server 20 is described in detail below. Content server 20 can be coupled to content consumer environment 40 in any manner through any type of communication link, such as the Internet, a LAN, a direct computer to computer connection, or the like. Clearinghouse 50 receives content transaction information and other information from content consumer environment 40 and forwards the information to the appropriate content provider 30 to permit content provider 30 to bill content consumer environment 40 for content. Clearinghouse 50 can be coupled to accounts at financial institutions to automatically debit the appropriate accounts. The operation of clearinghouse 50 generally is well known and this is not discussed in detail herein. For example, U.S. Pat. No. 6,389,402, the disclosure of which is incorporated herein by reference, discloses a system in which content transactions are tracked and billed by a clearinghouse.

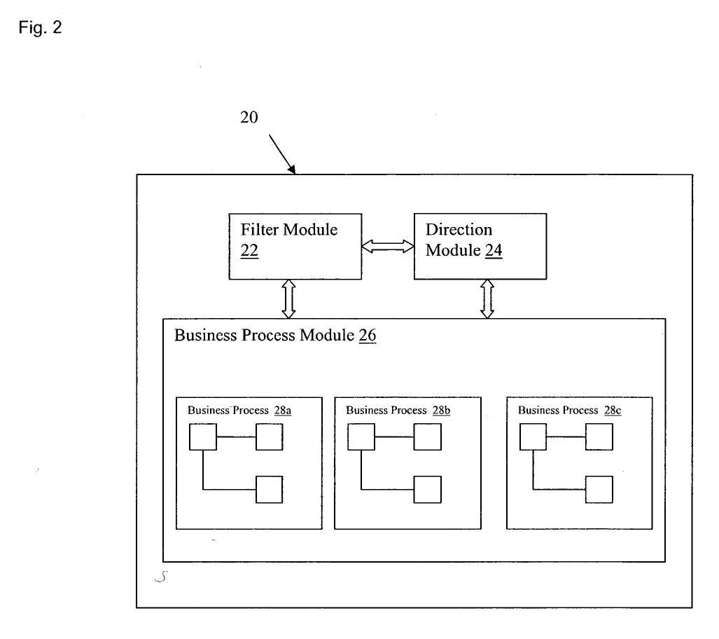

FIG. 2 illustrates content server 20 in greater detail. Content server 20 includes filter module 22 and direction module 24 for processing content from content provider 30. Filter module 22 filters content and direction module 24 directs content to appropriate content consumer 42. However, any type of processing of content can be provided by content server 20. Significantly, processing is accomplished by content server 20 in accordance with human capital needs of a user of each content consumer 42 in the user's role within the enterprise. This is accomplished by processing content in accordance with various business processes 28a stored in business process module 26. In particular, business processes of the various users, within their rules in the enterprise, associated with content consumers 42 are determined and recorded in business process module 26 as business process 28a. The business processes include workflows and other particulars of the user's role within an enterprise as described in greater detail below. Business processes 28a, 28b and 28c can be stored and manipulated in an object oriented environment such as business process modeling environments sold by Vitria Technology, Inc., WebMethods, Inc., and others. Such environments are well known for modeling and executing business processes and workflows to integrate information from various systems. Filter module 22 and direction module 24 filter and direct content to content consumer 42 in accordance with business process module 26. Determination of business processes in business process module 26 is described below.

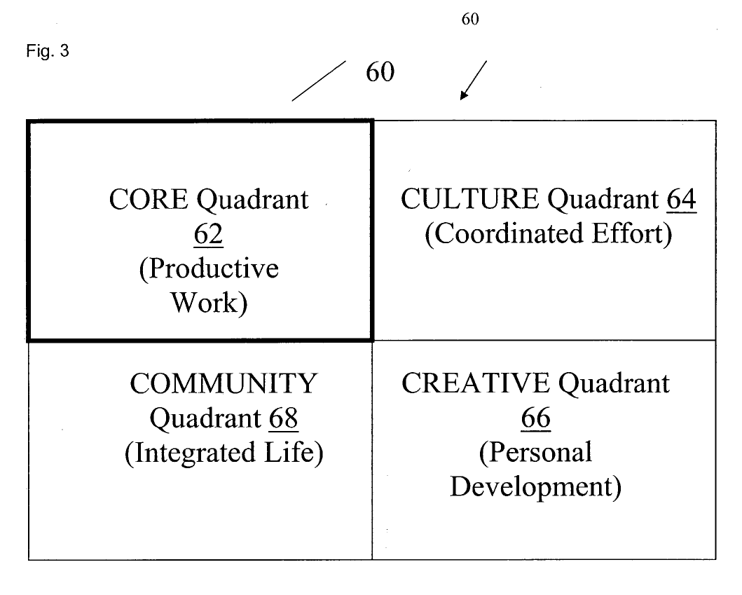

Each content consumer 42 includes a display or other rendering mechanism for presenting content to the user associated with content consumer 42. In the preferred embodiment content is segregated into quadrants. The term “quadrant” or “category” or “segment” as used herein refers to a logical separation of content and is not limited to any physical arrangement or display. As illustrated in FIG. 3, display 60 of the preferred embodiment can include content in core quadrant 62, content in culture quadrant 64, content in community quadrant 66, and content in creative quadrant 68.

Content in core quadrant 62 is content relating to the activities and behaviors that directly create value for the firm and the unique competencies that define a role, such as a position of employment, of the user in the organization. Information in this quadrant relates to the human capital that translates information to knowledge, and effort of the user directly to income for the enterprise. For example, in a sales department of a manufacturing company, content in core quadrant 62 is content that related directly to sale of the manufactured product. For a lawyer in a law firm, content in core quadrant 62 is content related directly to billable legal services. Note that core activities are based on the user's role within the enterprise. For example, core activities of a salesman are different from those of a human resource coordinator.

Content in culture quadrant 64 is content related to the collaboration of the user with others throughout the enterprise and the activities that create and reinforce the social dimensions of the enterprise. The culture supports the values, ethics, philosophy, and productivity of the firm while leveraging relationships and social networks. The culture is what enables economies of scale to add value and create wealth.

Content in creative quadrant 66 is content related to interests that are unique to each user and utilizing the resources that reinforce an individual's distinctive approach to information, knowledge acquisition, leisure time, and life in general. This quadrant also enables access to proprietary tools that facilitate personal and professional self-improvement and development planning, as described below.

Content in community quadrant 68 is content related to the integration of work, family, social, and professional life of the user. It is the world beyond the user's role in the enterprise, referring to the network of networks, i.e., family, friends, and other groups, such as church, school, and municipality that comprise one's life. It is the seamless integration of all communities-of-interest and the true balance between a role in an enterprise, such as work, and family.

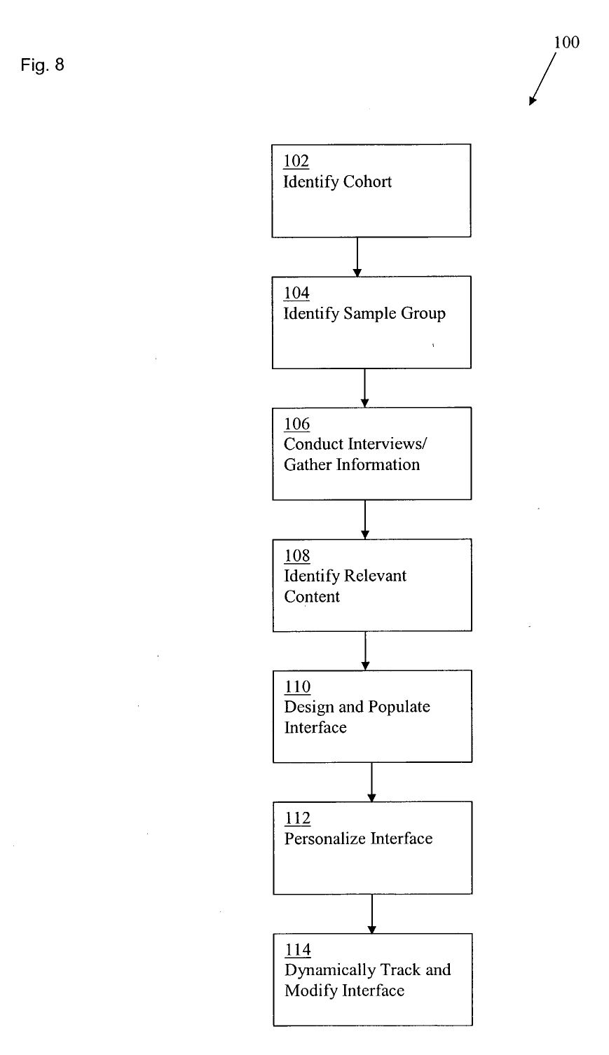

FIG. 8 illustrates the process for determining business processes in the preferred embodiment. Process 100 starts at step 102 in which a cohort is identified. The term “cohort” as used herein refers to a group of users having a substantially homogenous function. For example, the cohort can be members of a sales department of an enterprise or members of a legal practice group (in the case of a law firm as the enterprise), such as members of the real estate law group of the law firm. Of course, the persons in the cohort can have heterogeneous information needs and functions. Accordingly, the phrase “substantially homogenous” as used herein refers to a group of people participating in a common function or set of functions within the enterprise.

In step 104, a sample group of persons in the cohort, or related to the cohort, is selected. The sample group can be a portion of the cohort, or the entire cohort. With large cohorts, it may be desirable to select a representative cross section of the cohort for further processing to reduce resources. Also, the sample group can include persons outside of the cohort who interface with the cohort. For example if the cohort is lawyers in a real estate law practice, the sample group can include secretaries working with these lawyers, docketing clerks, clients of the attorneys, and the like. The sample group is selected with the objective of obtaining a full view of the work processes of the cohort.

In step 106, the sample group is interviewed using a structured or semi-structured format to determine various attributes of participation of users in business processes. Such attributes of participation can include the purpose of the process with respect to the user's role, the user's informational needs, and the like. The semi-structured interview format is a format in which specific questions are set forth to solicit free-form answers. In a structured format, the interviewee selects answers from a predetermined set, such as “True/False,” multiple choice, or the like. Results of a semi-structured interview can be used to derive a structured interview process. Rules or other algorithms can be used to map individual responses, or combinations of responses, to the interview questions to specific informational needs. The interview process is conducted in a manner to determine the business processes and thus information needs of the users within the community and is discussed in greater detail below.

In step 108, the interview results are used to determine relevant content for the cohort. This is referred to herein as “mass customization” of the content display. For example, the interview results might indicate that the cohort requires access to real estate sales data and enterprise accounting data as part of their “core tasks.” In step 110, the user interface, or “dashboard”, for the cohort is designed. Core quadrant data will contain external and internal information resources required by an individual's role within the enterprise. It will be similar for all members within a cohort, but not necessarily identical from individual to individual. This is because broad categories of needs will be similar, but specific needs will naturally vary. For example, a real estate attorney may need access to certain types of records, but the specific records may vary depending on locale. The interface can include common features for the cohort and the enterprise, and the individual. For example, regardless of the results of the interview process, the management of the enterprise may require that each have access to specific data, such as a roster of the enterprise, in their culture quadrant. Or that each have access to an individualized development plan in the creative quadrant. In step 112, the interface is personalized for selected members of the cohort based on options selected by them and the enterprise. Roles are further differentiated by additional responsibilities based on length of service, level of management, or other, enterprise determined, criteria. For example the enterprise management may require that certain persons in the cohort have access to specific information. As an example, in a law firm, all partners in the cohort might have access to firm financial reports, while all others in the cohort will not have such access. Or, in the culture quadrant, membership on certain committees such as a Software Committee, or Knowledge Management Committee, or Recruitment Committee, may necessitate access to specific information that others need not have available to them. In the process of personalizing the interface, these additional responsibilities need to be accounted for, and these specific information needs will be built-in to the a dashboard through the customization process. That is to say, individuals in a complex organization often have several roles, that is, they are members of more than one cohort. The cohort related to the core is often dominant, but other cohorts (e.g., committee membership) may be taken into account as well.

After step 112, the user interface is configured for initial operation. However, the user interface can be configurable in a dynamic manner in step 114. For example, users can rate the relevancy or other attributes of content received through the user interface and the ratings can be used to continuously or periodically reconfigure the user interface through rules or other algorithms. For example, highly rated content can be brought closer to the “front” of the interface and low rated material can be buried deeper or eliminated from all or specific users. The initial configuration and dynamic configuration are used to control filter module 22 and direction module 24 to thereby distribute content in accordance with business processes of each user.

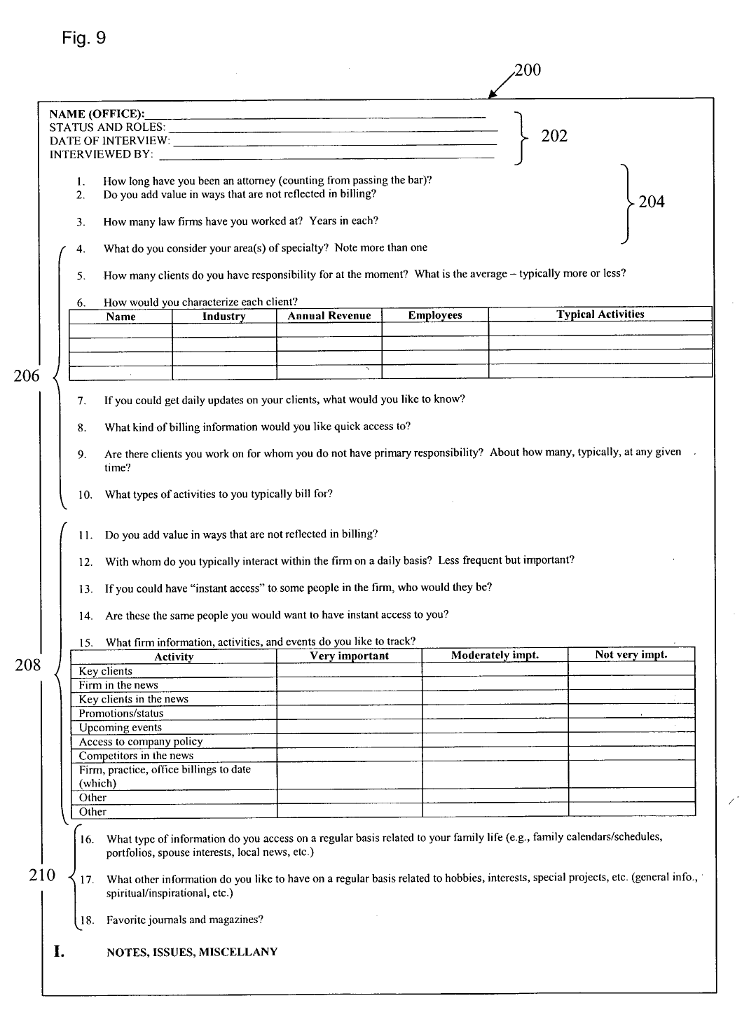

FIG. 9 illustrates an example of a questionnaire used for a semi-structured interview process in step 106. The example is adapted for use in a law firm as the enterprise and a lawyer as a user role within that enterprise. Of course, the questions can be modified to fit the needs of any type of enterprise and any type of roles within the enterprise. As illustrated in FIG. 9, questionnaire 200 includes general information fields 202 used to classify and track the interview. Questions content server 204 are used to establish seniority and experience of the person being interviewed. Content can be tailored for experience level based on the responses to these questions. For example, less experienced attorneys might have a legal dictionary prominently on their desktop. Also, tools can be specialized based on practice area. For example, an attorney noting that patent prosecution is their specialty might have a patent search tool on their desktop.

Questions 206 are directed primarily to ascertaining the desired content for the user's core quadrant 62. Questions 208 are directed primarily to ascertaining the desired content for the user's culture quadrant 64. Questions 210 are directed primarily to ascertaining the desired content for the user's community and creative quadrants Relative to the community quadrant, it will be ascertained whether there are individuals (e.g., spouse, children) with whom calendars must be coordinated, and institutions in the community (e.g., schools, churches) where public events should be accessed and calendared. In terms of creative quadrant, specific, preferred sources of content will be ascertained. In addition, the development plan, which resides in this quadrant, can be populated by specifying the competencies and specific tasks an individual plans to work on to improve their functioning, capabilities, and value to the company and the marketplace. Note that the interface configuration determined in steps 108 through 112 can be based on applying the answers to the questions to rules or other algorithms in simple correspondence or through complex processing. The answers can be used in aggregate, for individuals or in any manner or combination thereof, to ascertain the business processes and information needs of the user and the community, all within their roles in the organization.

For example, the questionnaire 200 can be presented as a structured questionnaire in the form of a computer based form with selection boxes for each answer. The answers can be automatically processed in any manner to distribute content as needed. As a specific example of such processing, the answers can be transposed to a matrix and rules can be applied to unique values of the matrix.

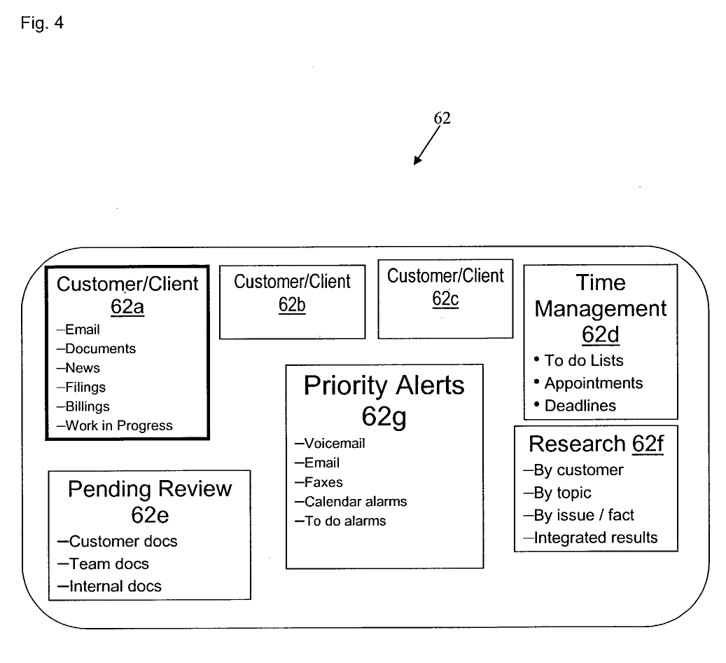

FIG. 4 is an example of a display corresponding to core quadrant 62 of FIG. 3. For example, the display can be rendered on the screen of a users personal computer or other device serving as content consumer 42 for that user. Once again, the core quadrant includes information that relates directly to activities and behaviors of the specific user's role that directly create value for the enterprise. Of course, such activities and behaviors will differ based on the goals of the organization and the role of the user. The core activities support the unique competencies that define the role within the enterprise that directly creates value for the firm in the form of income for the enterprise. Therefore, the core quadrant includes information that directly supports the business processes of core activities and behaviors of the user. Windows 62a, 62b, and 62c each include customer/client information for a specific customer or client. For example, these windows can contain content such as email messages from customers, documents related to customers, billing or accounting information about customers, work product and the like. In FIG. 4, window 62a has been selected by the user using standard user interface techniques, such as a mouse selection and drop-down menu. Therefore, window 62a is shown as being “open” to show a detailed menu that can be further selected by the user. Of course, there can be any number of customer/client windows and they can be arranged in any manner, each element in the window can be a link or a drop-down display to permit the user to “drill down” into the content in the specific window. Further, each window can include plural levels of menus and windows to facilitate navigation through content (As discussed above, there may well be additional roles that an individual has in an organization or other enterprise, or in their life, that is supported by the preferred embodiment in order to maximize the human capital, or knowledge, that an employee brings to the job. These additional roles may be supported by information in the core quadrant, or the culture, creative, or community quadrants).

Window 62d is directed to time management content and includes “to do” lists, a calendar of appointments, deadlines (docketing information in the case of attorneys), and the like. Window 62e is directed to content requiring review by the user. Window 62f is directed to priority alerts, including calendar alarms, priority messages, and the like. Window 62f is directed to research content. Each window can include one ore more drop down menus, folder trees, selection boxes, or other interface mechanisms to permit selection and drill down of content. All content in core quadrant 62 is controlled by content server 20 and correspond, to the core activities of the user based on business processes 28a, 28b, 28c.

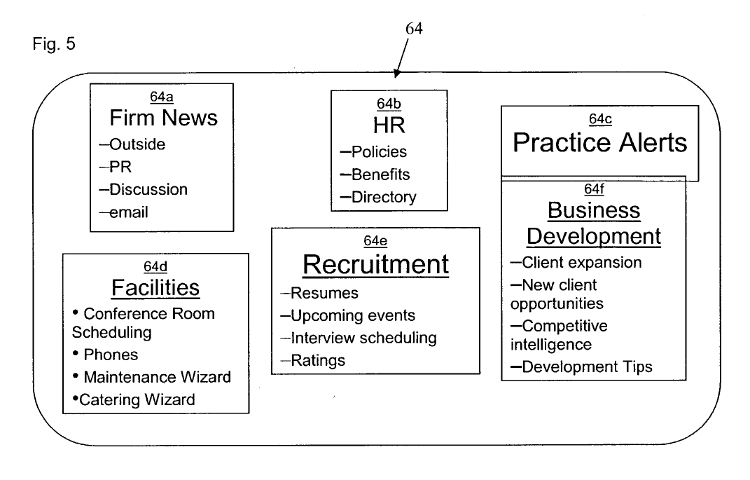

FIG. 5 is an example of a display corresponding to culture quadrant 64. Once again, culture activities and behaviors include those that relate to collaboration throughout the enterprise and include activities that create and reinforce the social dimensions of the enterprise as well as the values, ethics, philosophy, and productivity of the enterprise as a whole. Information that supports cultural activities can include Human Resource Manuals, activities and schedules, coworker information (such as directories), and facilities information. Window 64a displays firm news such as outside news relating to the enterprise, public relations information, discussion groups relating to culture activities, and email messages relating to culture activities. Window 64b includes Human Resources information, such a policies, benefits, and an enterprise personal directory. Window 64c displays practice alerts or other cohort or culture related information. For example, in a law firm, the tax group could receive alerts relating to proposed changes in the tax law. Window 64d displays facilities information such as conference room schedules, phone lists, a maintenance request wizard, a catering request wizard, and the like. Window 64e displays information relating to recruitment, such as resumes submitted by potential employees, events, interview schedules, interviewee ratings, and the like; this window would only appear if the user had a role in the organization that required him or her to be informed about recruitment efforts. Window 64f displays information relating to business development, such as expansion of existing clients/customers, new business opportunities, intelligence relating to competitors, and business development tips. As noted above, each element in the window can be a link or a drop down display to permit the user to “drill down” into the content in the specific window. Further, each window can include plural levels of menus and windows to facilitate navigation through content.

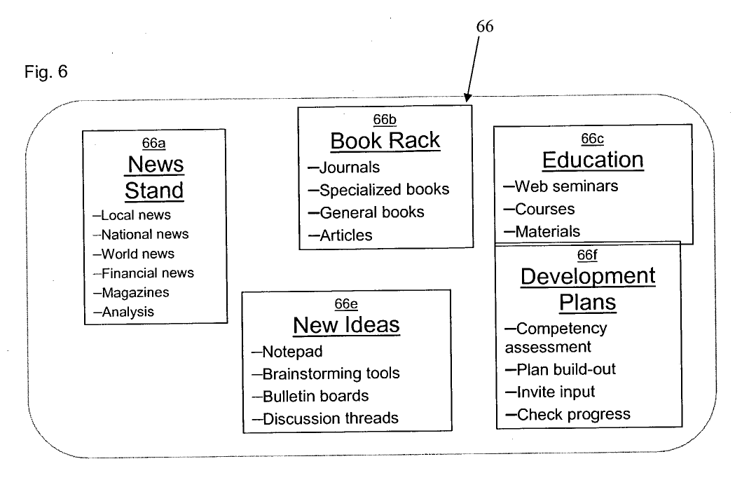

FIG. 6 is an example of a display corresponding to creative quadrant 66. Once again, creative activities and behaviors include those that relate to the creativity of the user within their role in the enterprise. For example, content in the creative quadrant can include periodicals and books, seminars, plans and goals, and mentoring input. Window 66a displays general news items such as local news, world news, financial news and the like. Note that this news is distinguished from the news in window 64a because it does not relate to the enterprise in any direct manner but rather is intended to encourage the personal development of the user. Window 66b includes links to books, journals and articles. Window 66c displays educational materials, such as seminars, courses and other educational materials. Window 66d displays new idea items, such as notes, brainstorming tools (e.g. a collaborative “whiteboard”), bulletin boards, and discussion groups. Window 66e displays information relating to development plans, such as competency assessments, plan build outs, input invites/requests, and progress checking tools. As noted above, each element in the window can be a link or a drop down display to permit the user to “drill down” into the content in the specific window. Further, each window can include plural levels of menus and windows to facilitate navigation through content.

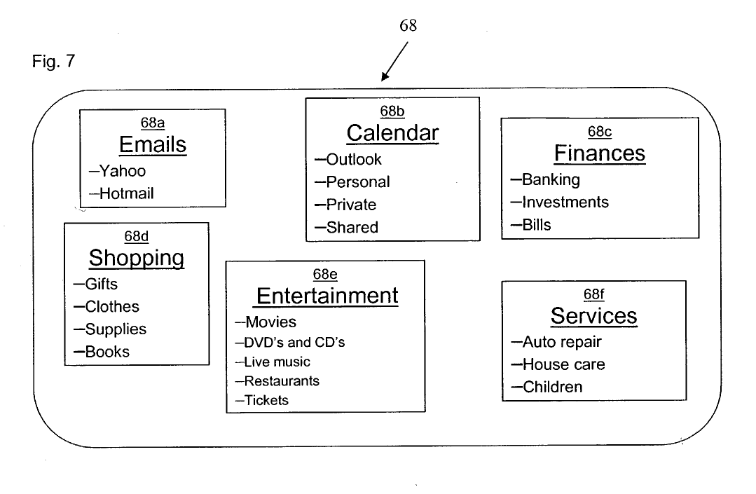

FIG. 7 is an example of a display corresponding to community quadrant 68. Once again, community activities and behaviors include those that relate to the integration of work and family, social, and professional activities. For example, content in the creative quadrant can include information relating to social networks, family, friends, church groups, and the like. Much of the content in community quadrant 68 is the type of content that employers often do not wish to be included in the enterprise resources because it is deemed to distract the user from their work tasks. However, such information is often accessed through work resources in an inefficient and often clandestine manner. In the preferred embodiment, because this information is segregated, it does not infringe on the other activities of the user but merely serves to help the user feel more fulfilled in life and thus more productive at work. Window 68a displays links to personal email accounts, such as Yahoo™ and Hotmail™ accounts. Window 68b includes access to the user's calendar(s) including work, personal, private, and shared calendars. Window 68c displays content related to the user's personal finances, such as banking, investments, and bills. Window 68d displays shopping information such as lists and shopping venues for clothes, gifts, supplies, and books. Window 68e displays information relating to entertainment, such as movies, media rentals, live music venues, restaurants, and ticket information. Window 68f displays information relating to personal or household services, such as auto repair, house care, and child/family related services and activities. Once again, each element in the window can be a link or a drop down display to permit the user to “drill down” into the content in the specific window. Further, each window can include plural levels of menus and windows to facilitate navigation through content.

The segregation of content into quadrants, or more generally categories or segments, permits the user to obtain information relating to all aspects of their professional and personal life while avoiding inter-mingling of unrelated information. In fact, the user can “own” quadrants, such as the community quadrant and the enterprise can “own” quadrants such as the core quadrant. This permits users to retain personal information after leaving an enterprise while protecting the enterprise's confidential and proprietary data. Note that the various quadrants can contain similar or overlapping content. In fact, the quadrants are not necessarily exclusive but are focused on a particular aspect of the user. Further, one quadrant's activities may be partially or entirely within another quadrant. For example, the core quadrant can be considered a subset of the culture quadrant. However, the core portion can be carved out of the culture portion to leave remaining activities/content to be part of the culture quadrant.

Each quadrant display can be configured in any manner to display any appropriate content. Further, not all quadrants are necessary in each instance and other display areas can be used. The preferred embodiment can use standard user interface techniques. For example, the display can be accomplished through a known portal product, such as the Plumtree™ portal. The invention can utilize any type of computer, computer network, or system of other devices. For example, the content consumer devices can be personal computers, thin clients, terminals, PDAs, cell phones, or other devices associated with a user. Various communication channels can be used to communicate content and other information. For example, LANS, WANS, or the internet can be used. The preferred embodiment can be applied to any enterprise in any industry. Communities and cohorts can be defined and segregated in any manner. Further, any type of rules or algorithms can be used to determine content distribution and display. The enterprises can limit the availability of content in any manner.

The invention has been described through a preferred embodiment. However, various modifications can be made without departing from the scope of the invention as defined by the appended claims and legal equivalents.

What is claimed is:

1. A content distribution system for providing content to users within an enterprise based on the roles of user's within the enterprise, said system comprising:
at least one source of items of content;
at least one content consumer device;
a content server configured to accept items of content from said source and process the items of content for said content consumer device in accordance with human capital needs of a user of said content consumer device serving in at least one role within the enterprise.

2. A content distribution system as recited in claim 1, wherein the human capital needs include business processes of the user within the role.

3. A content distribution system as recited in claim 2, wherein the content server is configured to process the items of content by filtering the items of content and directing the items of content to a specific content consumer device based on the business processes of the user of the specific content consumer device within the role of the user.

4. A content distribution system as recited in claim 1, wherein the human capital needs include human capital development.

5. A content distribution system as recited in claim 1, wherein the human capital needs include human capital deployment.

6. A content distribution system as recited in claim 1, wherein the human capital needs include organization of content items in accordance with the professional and personal informational needs of the user.

7. A content distribution system as recited in claim 6, wherein the content items are segregated into Core, Culture, Community, and Creative categories.

8. A content distribution system as recited in claim 1, wherein said human capital needs are determined by attributes of participation of the user of said content consumer device in at least one business process.

9. A content distribution system as recited in claim 8, wherein the attributes of participation include the purpose of the business process for the user with respect to an enterprise.

10. A content distribution system as recited in claim 9, wherein the attributes of participation are obtained through an interview processof at lease some of the users.

11. A content distribution system as recited in claim 7, wherein said Core category includes content items relating to activities that directly credit value for the enterprise in the at least one role of the user within the enterprise.

12. A content distribution system as recited in claim 7, wherein said Culture category includes content items related to the collaboration of a user with others in the enterprise.

13. A content distribution system as recited in claim 7, wherein said creative category includes content items related to the user's personal and professional creative development.

14. A content distribution system as recited in claim 7, wherein said community category includes content items related to the user's life outside of the enterprise.

15. A content distribution system as recited in claim 1, wherein said sources comprise an email server.

16. A content distribution system as recited in claim 1, wherein said sources comprise a database.

17. A content distribution system as recited in claim 1, wherein said sources comprise an internal enterprise business process system.

18. A content distribution system as recited in claim 1, wherein the enterprise is a workplace of the user.

19. A content distribution system for providing content to users within an enterprise based on at least one role of the users within the enterprise, said system comprising;
at least one source of plural items of content;
at least one content consumer device;
means for determining attributes of participation of a user of said content consumer device in at least one business process, the attributes of participation including the purpose of the at least one business process of an enterprise.
a content server configured to accept items of content from said source and provide relevant items of content to said content consumer device in accordance with the attributes of participation, said content server being operative to segregate the relevant items of content into display segments based on the attributes of participation.

20. A content distribution system as recited in claim 19, wherein the display segments include a segment for items of content related to activities of the user that create value for the enterprise, a segment for items of content that relate to collaboration between the user and others in the enterprise, a segment for items of content that relate to unique interests of the user within the enterprise, and a segment for items of content that relate to interests of the user outside of the enterprise.

21. A content distribution system as recited in claim 19, wherein the attributes of participation are obtained through an interview process of at least some of the users.

22. A content distribution system as recited in claim 19, wherein said sources comprise an email server.

23. A content distribution system as recited in claim 19, wherein said sources comprise a database.

24. A content distribution system as recited in claim 19, wherein said sources comprise an internal enterprise business process system.

25. A content distribution system as recited in claim 19, wherein the enterprise is a workplace of the user.

26. A display system for use in connection with a content distribution system of an enterprise, said display system comprising:
means for segregating items of content into display segments based on the attributes of participation of a user in business processes of an enterprise; and
means for displaying the items of content in one of plural display segments including a segment for items of content related to activities of the user that create value for the enterprise, a segment for items of content that relate to collaboration between the user and others in the enterprise, a segment for items of content that relate to unique interests of the user within the enterprise, and a segment for items of content that relate to interests of the user outside of the enterprise.

27. A display system as recited in claim 26, wherein said means for segregating comprises means for determining the attributes of participation and means for processing the items of content in accordance with the attributes of participation.

28. A display system as recited in claim 26, wherein said means for displaying comprises means for generating at least one display screen corresponding to each display segment.

29. A method for determining a user's participation in business processes of an enterprise in the context of the user's role within the enterprise for the purpose of distributing content to the user that enhances the user's role within the enterprise.

30. A method for providing content to users within an enterprise based on the roles of user's within the enterprise, said method comprising:
determining human capital needs of a user of a content consumer device serving in a role within the enterprise;
receiving items of content from at least one source of items of content;
providing selected items of content to the content consumer device in accordance with human capital needs of the user of said content consumer device serving in at least one role within the enterprise.

31. A method as recited in claim 29, wherein said determining step comprises determining business processes of the user within the at least one role, and said providing step comprises providing the selected items of content in accordance with the business processes of the user.

32. A method as recited in claim 31, wherein said providing step comprises filtering the items of content and directing the items of content to a specific content consumer device based on the business processes of the user of the specific content consumer device within the role of the user.

33. A method as recited in claim 30, wherein the human capital needs include human capital development.

34. A method as recited in claim 30, wherein the human capital needs include human capital deployment.

35. A method as recited in claim 30, wherein the human capital needs include organization of content items in accordance with the professional and personal informational needs of the user.

36. A method as recited in claim 35, wherein said providing step comprises segregating the content items into Core, Culture, Community, and Creative categories for specific users.

37. A method as recited in claim 30, wherein said determining step comprises determining attributes of participation of the user of said content consumer device in at least one business process.

38. A method as recited in claim 37, wherein the attributes of participation include the purpose of the business process for the user with respect to an enterprise.

39. A method as recited in claim 38, wherein the attributes of participation are obtained through an interview process with at least some of the users.

40. A method as recited in claim 36, wherein said Core category includes content items relating to activities that directly credit value for the enterprise in the at least one role of the user within the enterprise.

41. A method as recited in claim 36, wherein said Culture category includes content items related to the collaboration of a user with others in the enterprise.

42. A method as recited in claim 36, wherein said creative category includes content items related to the user's personal and professional development that leads to an increase of skills, knowledge, or ability.

43. A method as recited in claim 36, wherein said community category includes content items related to the user's life outside of the enterprise.

44. A method as recited in claim 30, wherein the enterprise is a workplace of the user.

45. A method of determining the informational needs of a cohort of users in a manner that increases the human capital value of the users in their at least one role within an enterprise, said method comprising:
identifying a cohort of users having substantially homogenous roles within the enterprise;
identifying a sample group of users corresponding to the cohort of users;
gathering data of the users in the sample group relating to business processes of the community;
determining business processes of the cohort based on user response to the data;
identifying content that is relevant to the business processes determined in said determining step; and
designing an interface for presenting the relevant content.

46. A method as recited in claim 45, wherein said sample group is a subset of a cohort of business users in a community;

47. A method as recited in claim 45, wherein said sample group includes users within the cohort, and persons in roles within the community or organization, beyond those of the cohort.

48. A method as recited in claim 45, wherein said conducting step comprises conducting a semi-structured interview of each person in the sample group relating to their information needs, business processes, and information usage patterns.

49. A method as recited in claim 45, wherein said conducting step comprises conducting a structured interview, of each person in the sample group.

50. A method as recited in claim 49, wherein said conducting step comprises conducting the interview through a computer based form.

51. A method as recited in claim 50, further comprising the steps of tracking usage of content and adjusting the content of the interview based on said tracking step.

52. A method as recited in claim 45, wherein said gathering step comprises conducting an interview of at least some of the users in the sample group.
